(19) United States
(12) Patent Application Publication
(10) Pub. No.: US 2007/0143445 A1
(43) Pub. Date: Jun. 21, 2007

(54) Method for offering and refreshing digital content on fixed image platforms

(76) Inventors: Shree A. Dandekar, Round Rock, TX (US); Gaston M. Barajas, Austin, TX (US); William P. Hyden, Round Rock, TX (US)

Correspondence Address: HAMILTON & TERRILE, LLP, P.O. BOX 203518, AUSTIN, TX, 78720, US

(21) Appl. No.: 11/313,363

(22) Filed: Dec. 20, 2005

(51) Int. Cl. G06F 15/16

(52) U.S. Cl. 709/219

(57) ABSTRACT

A method of offering and refreshing content on fixed image platforms which includes storing a fixed image on an imaging server, storing content which is regularly updated in an imaging server, merging the fixed image and at least some of the content to provide a merged fixed image, and installing the merged fixed image onto a fixed image platform is disclosed.

### BACKGROUND OF THE INVENTION

1. Field of the Invention

The present invention relates to build to order systems, and more particularly, to offering and refreshing content on fixed image platforms.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take-advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide a customer with an ability to configure and order an information handling system via an on-line store. The on-line store includes a configurator that allows the customer to customize and procure the system on-line. The configurator allows the customer to select a given system model and to customize the system according to the user selected options.

After a system is configured, the customer may be provided the opportunity to order particular software, services or content. When the customer indicates a desire to order such software, services or content, the customer can order the software services content via the on-line store.

Additionally, it is known to provide built to order information handling systems with content and services at the point of sale of the information handling system. The content includes games, movies, etc. One challenge associated with offering content at the point of sale relates to lower end types of information handling systems which often are configured to include a base software and services stack. During the manufacture of the information handling system, this base software and services stack is loaded onto the information handling system via a fixed image. However, it is desirable that this content be refreshed often, as the type of content that a customer desires often changes. For example, new movies are released every week that a customer might be interested in viewing.

There are a number of challenges associated with known fixed image install processes. For example, known fixed image install processes can present a relatively long burn time for loading large amounts of content onto the system being fabricated. Also, the size of the content can be rather large, especially as more options (e.g., more movies and games) are provided on the fixed image. Also, known processes are often not flexible regarding increasing the size of the image to accommodate more content. Also, with known processes, it is difficult to change the content, which change requires changing the fixed image, on a regular basis. The development or change of the fixed image can be rather time consuming.

What is needed is an efficient process for offering and refreshing content on fixed image platforms.

### SUMMARY OF THE INVENTION

In accordance with the present invention, an efficient process for offering and refreshing content on fixed image platforms is set forth in which content is hosted on imaging servers, which are in turn used to generate the fixed images that are installed onto the information handling systems. The content stored on the imaging servers is updated on a regular basis by content providers. The imaging server then generates an updated content listing and provides this content listing to a database for an information handling system configurator. Based upon this update, the online store can refresh its offerings to customers. The customer can then select the content to be preinstalled onto the information handling system that is being configured. Based on this selection, a list of content is appended to the order. An order management system then provides this information to the imaging server for configuring the information handling system. The imaging server then uses an image appending program to generate a final image which includes the customized content for the customer's system.

Additionally, in one embodiment, the process includes using a license management server that interacts with imaging servers which store the content. The license management server analyzes the content provided by content providers to assure that the content includes distributable licenses. If the content provider has not provided the appropriate license for distribution, then the imaging server does not allow the content to be installed onto built to order information handling systems.

In one embodiment, the invention relates to a method of offering and refreshing content on fixed image platforms which includes storing a fixed image on an imaging server, storing content which is regularly updated in an imaging server, merging the fixed image and at least some of the content to provide a merged fixed image, and installing the merged fixed image onto a fixed image platform.

In another embodiment, the invention relates to an apparatus for offering and refreshing content on fixed image platforms which includes means for storing a fixed image on an imaging server, means for storing content which is regularly updated in an imaging server, means for merging the fixed image and at least some of the content to provide a merged fixed image, and means for installing the merged fixed image onto a fixed image platform.

In another embodiment, the invention relates to a system for offering and refreshing content on fixed image platforms which includes an imaging server, a merge module and an install module. The imaging server stores a fixed image and regularly updated content. The merge module merges the fixed image and at least some of the content to provide a merged fixed image. The install module installs the merged fixed image onto a fixed image platform.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows an example of an automated build to order system for installing fixed image software on an information handling system.

FIG. 3 shows access to the on-line store and a content channel via the Internet using a computer system.

FIG. 4 shows a system block diagram of an information handling system.

FIG. 5 shows a block diagram of a system for offering and refreshing content on fixed image platforms.

FIG. 6 shows a block diagram of the process of installing the fixed image along with customized content onto a plurality of information handling systems.

### DETAILED DESCRIPTION

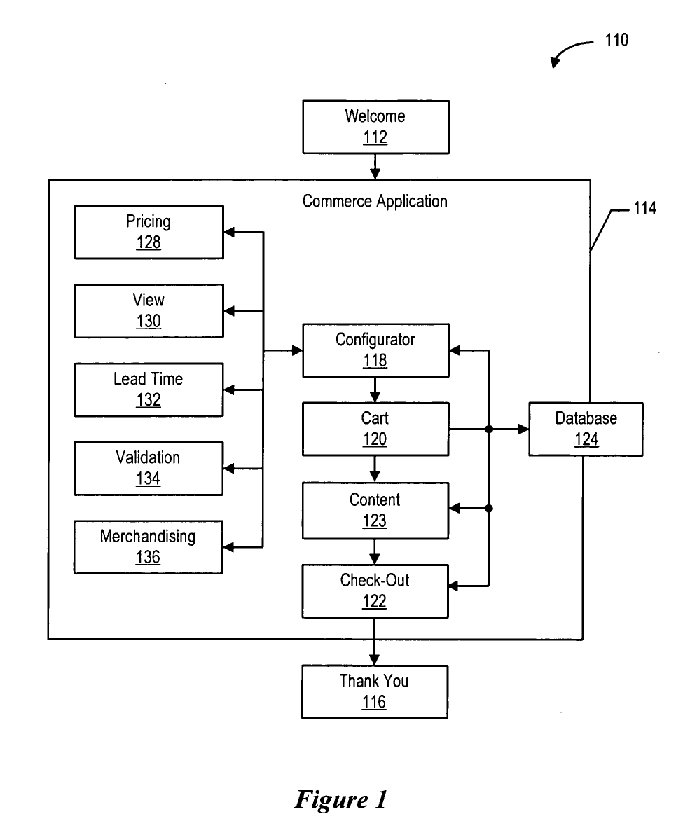

Referring to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a services activation module 123 and database 124. The database 124 provides information to the configurator 118, shopping cart 120, checkout module 122 and content module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and content module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the content module 123 presents a content selection page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, a customer is transferred to a content page in which the customer is provided an opportunity to select various content such as music, video streaming, training or games to have installed onto the system. After completion of the content module 123, the customer is transferred to a checkout page. After completion of the checkout, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and content module 123 are each part of the commerce application 114 and interact with the database 124. For example, with the shopping cart 120, additional merchandising information associated with a particular system which has been configured and placed in the shopping cart by an on-line store customer can be provided.

Also for example, various content may be provided for order by the customer by the content module 123 based upon the type of system ordered as well as components that are included within the system ordered. Additionally, by providing the content module within the commerce application 114, the customer continues the experience a similar customer experience and the system provider is able to use the information from the database 124 and to maintain control over the customer contact. By maintaining control over the customer contact the system provider is able to determine what content is selected and to maintain accurate and up to date records of the selected content.

Additionally, the content module 123 can provide a customer with an option of how much content to preload onto the information handling system during the manufacture of the information handling system.

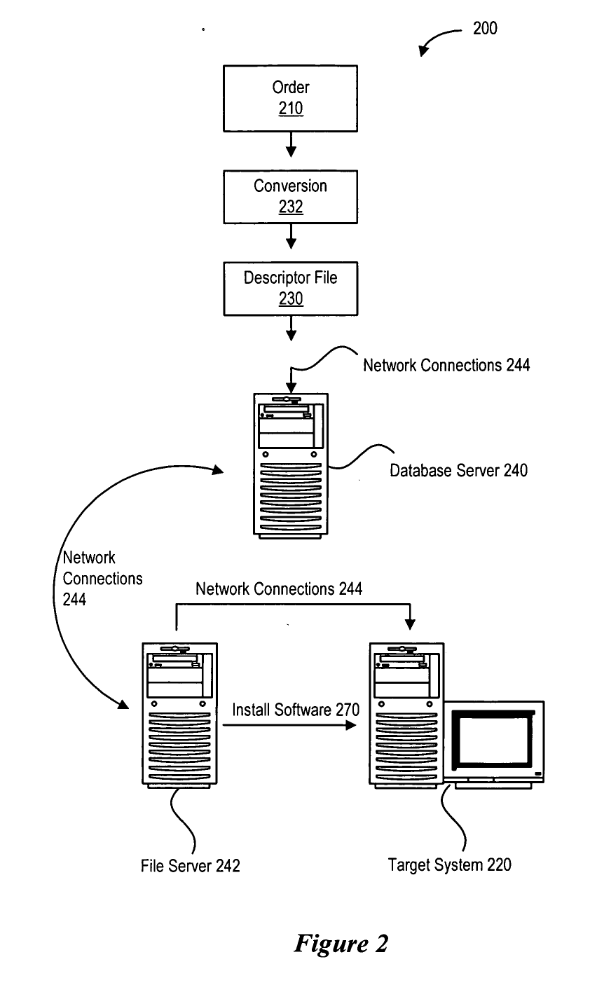

Referring to FIG. 2, a schematic diagram of a software installation system 200 at an information handling system manufacturing site is shown. In operation, an order 210 is placed to purchase a target information handling system 220. The target information handling system 220 (e.g., the fixed image platform) to be manufactured contains a plurality of hardware and software components. For instance, target information handling system 220 might include a certain brand of hard drive, a particular type of monitor, a certain brand of processor, and software. The software includes a particular version of an operating system along with all appropriate driver software and other application software along with appropriate software bug fixes. The software also includes ordered content as well as any additional local content to be installed by the manufacturer.

Before target information handling system 220 is shipped to the customer, the plurality of components are installed and tested from, for example, a fixed image of the software. Such software installation and testing advantageously ensures a reliable, working information handling system which is ready to operate when received by a customer.

Because different families of information handling systems and different individual computer components require different software installation, it is necessary to determine which software to install on a target information handling system 220. A descriptor file 230 is provided by converting an order 210, which corresponds to a desired information handling system having desired components, into a computer readable format via conversion module 232. The descriptor file 230 can also include which content to load on the system.

Component descriptors are computer readable descriptions of the components of target information handling system 220 which components are defined by the order 210. In a preferred embodiment, the component descriptors are included in a descriptor file called a system descriptor record which is a computer readable file containing a listing of the components, both hardware and software, to be installed onto target information handling system 220. Having read the plurality of component descriptors, database server 240 provides a plurality of software components corresponding to the component descriptors to file server 242 over network connection 244. Network connections 244 may be any network connection well-known in the art, such as a local area network, an intranet, or the internet. The information contained in database server 240 is often updated such that the database contains a new factory build environment. These updates can include new content to install onto the fixed image platform. The software is then installed 270 on the target information handling system 220. The software installation is controlled by a software installation management server that is operable to control the installation of the operating system and other software packages specified by a customer.

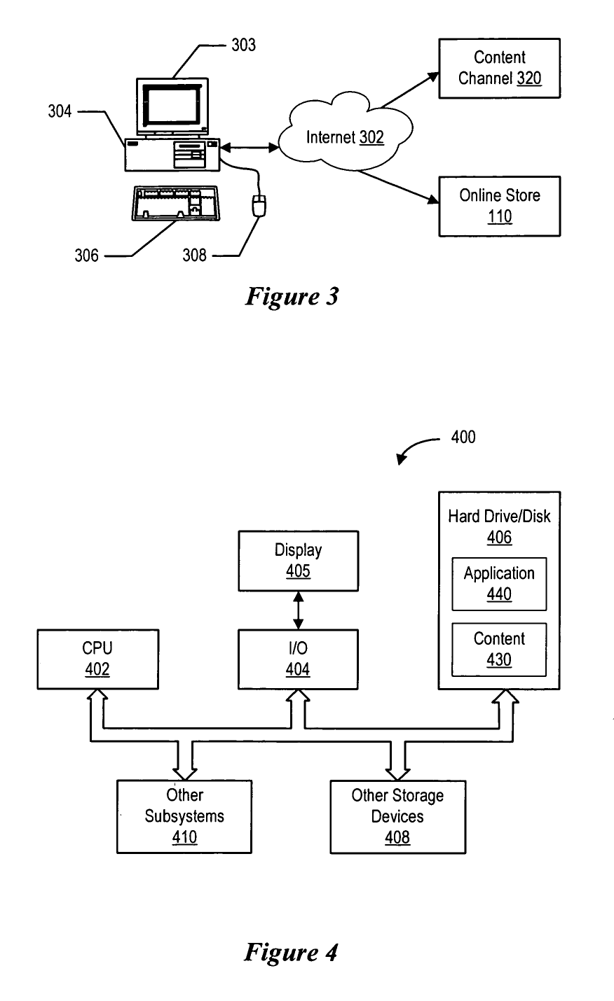

Referring to FIG. 3, a customer can access the on-line store 110 using any suitable computer equipment 300 via the Internet 302. The computer equipment 340 may include a display 303, computer 304, keyboard 306, and pointing device 308. Display 303 is used for displaying the various pages of the on-line store while a customer is using the on-line store. The computer equipment 300 can also access a content channel 320 such as a manufacturer content channel via the Internet 302.

Referring briefly to FIG. 4, a system block diagram of an information handling system 400 is shown having features thereof configured in accordance with the on-line store 110. The information handling system 400 includes a processor 402, input/output (I/O) devices 404, such as a display, a keyboard, a mouse, and associated controllers, a hard disk and drive 406, and other storage devices 408, such as a floppy disk and drive and other memory devices, and various other subsystems 410, all interconnected via one or more buses 412. The information handling system 400 also includes local content 430 and a content portal application 440 that accesses the content 430 stored on the non-volatile memory

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

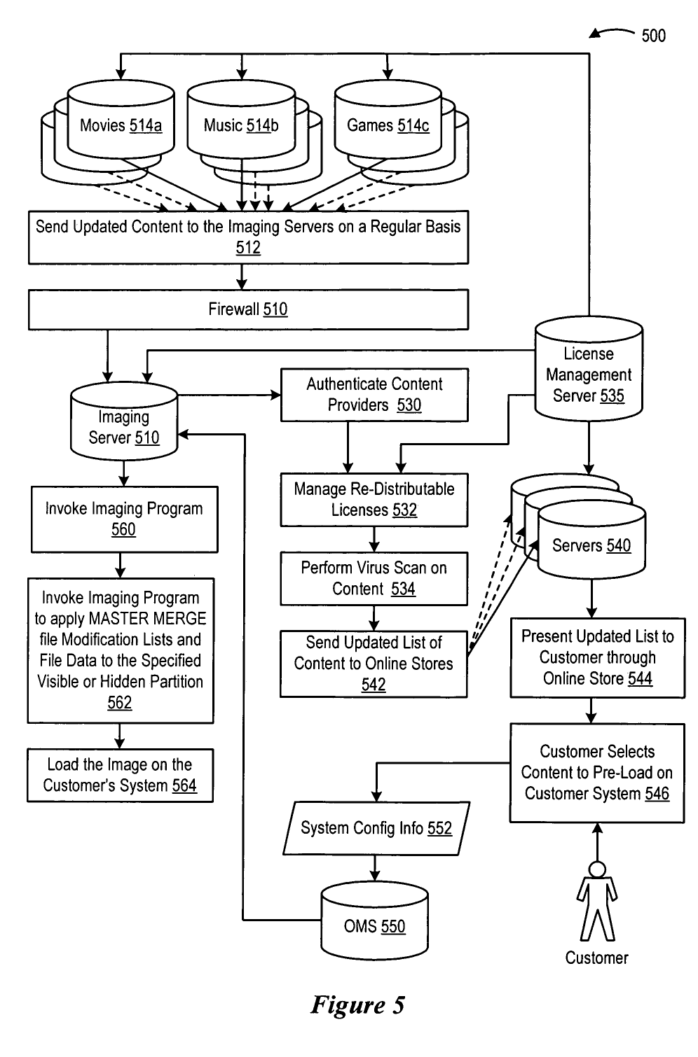

Referring to FIG. 5, a block diagram of a system 500 for offering and refreshing content on fixed image platform is shown. More specifically, an imaging server 510 is updated at step 512 with content, such as movies 514a, music 514b and games 514c, on a regular (e.g., monthly) basis. The content is provided by content providers that are located outside of the firewall 520 of the image server 510. The content may be provided digitally from the content providers to the imaging server 510.

When the imaging server 510 is updated, the content providers are authenticated at step 530 and licenses for the content are managed at step 532. Each piece of content is also scanned for viruses at step 534.

A license management sever 535 communicates with the content providers to manage the licenses. The license management server 535 also communicates with the image server 510 to link the license information received from the content providers with respective content. The license management server 535 also communicates with the servers of the online store to ensure that only content having valid licenses are offered via the online store. Managing the licenses includes checking to determine that each piece of content includes a respective redistributable license. For existing content, the license management server 535 assures that any time sensitive content licenses have not expired and if so obtains a renewal of the time sensitive content license. For new content, the license management server 533 obtains the licenses for the content from the appropriate content provider. By providing the licenses from the content providers onto the imaging server, the licenses for content may be installed onto an information handling system when the content to which the license corresponds is installed onto the information handling system.

After the content providers are authenticated and the content is analyzed and scanned, an updated list of available content is provided to the servers 540 of the online store 110 at step 542. After the available content is updated, then this information is presented via the content module 123 of the on-line store 110 at step 544. During the configuration process, a customer selects content to preload onto the customer system at step 546. The online store 110 provides system configuration information to a manufacturer order management system 550 at step 552.

The manufacturer order management system 550 provides the information regarding selected content to the imaging server 510. During the fabrication of the fixed image information handling system 220, an imaging program (which is executing, e.g., within file server 242) is invoked to generate image addendum files at step 560. The imaging program creates image addendum files, such as PowerQuest PQA addendum files, by packaging and compressing all of the files changes and data into a deployable package of software. Next, the imaging program is invoked to perform a master merge function at step 562. The master merge function merges file modification lists and file data to a specified visible or hidden partition to provide a merged image. Next, the merged image is loaded onto the customer's information handling system at step 564, e.g., by installing the software 270.

The factory installed local content storage can be updated regularly based on real world customer usage to better align with customer's content download tendencies.

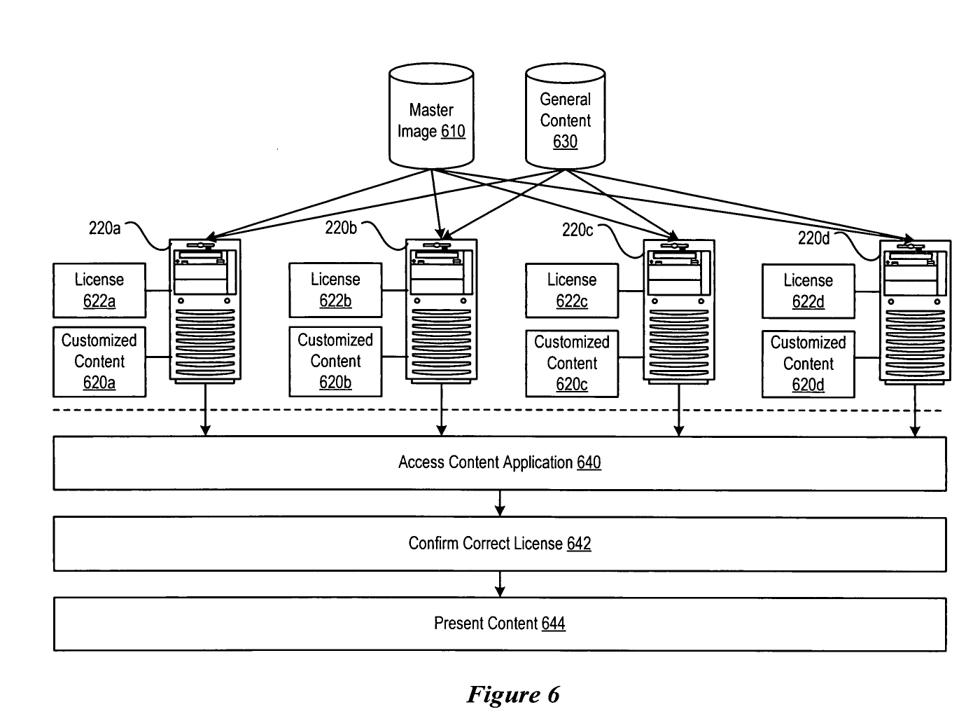

Referring to FIG. 6, a block diagram of the process 600 of installing the fixed image along with customized content onto a plurality of information handling systems is shown. A master image of the installed software 610 includes the software fixed image as well as the content application 440. When installing the fixed image onto a particular target system 220a, 220b, etc, the customized content 620a, 620b selected by the customer during the configuration process is also installed onto the respective target system. The customized content is stored on the imaging server 510 and is installed onto the fixed image platform in addition to the master image 610. Additionally, a license module 622 is installed onto the fixed image platform having the licenses for the general content and the customized content 620 that was installed onto the fixed image platform. The licenses are installed from the license management server 535.

In this way, each target information handling system 220 includes the standard fixed image that was developed for the type of target information handling system as well as the customized content 622 that was selected by the user. Additionally, generally applicable content 630 may be installed from the imaging servers onto all target information handling systems 220 of a particular type. For example, all of the target information handling systems 220 might have a set of previews of coming attractions installed onto them, while only movies selected by a particular customer are installed onto a particular target information handling system.

Additionally, each target information handling system 220 includes the licenses for the content that is installed onto the target information handling system 220. When a user attempts to access this content, there is no need for the user to communicate with the content provider to validate or acquire a license for the content. Thus, the user may even access the content when not connected to the internet, such as when traveling in some sort of vehicle that does not have internet access.

By storing the general content 630 onto the target information handling systems 220 as a separate file or files, the general content may be easily and efficiently updated without needing to update the master image 610.

Thus, the content is packaged within a separate module and is installed separately from the factory install of the client application onto a plurality of target systems 220.

When a user receives the information handling system 220, the user can access the content application 440 at step 640. The content application 640 assures and confirms that the content has the appropriate licenses at step 642 and then presents the content at step 644.

### Other Embodiments

Other embodiments are within the following claims.

For example, the configurator which interacts with the database 124 may be used by a telephone sales person when a system is being ordered via the telephone. By maintaining control over the customer contact the system provider is able to determine what content is ordered and to maintain accurate and up to date records of the service activation.

Also for example, while specific types of content are identified, other content may also be selected by the content module.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method of offering and refreshing content on fixed image platforms comprising:
storing a fixed image on an imaging server;
storing content in an imaging server, the content being regularly updated;
merging the fixed image and at least some of the content to provide a merged fixed image; and
installing the merged fixed image onto a fixed image platform.

2. The method of claim 1 further comprising:
enabling a customer to select content to be installed on the fixed image platform.

3. The method of claim 1 further comprising:
presenting a list of content available for install, the list of content available being updated when the content is updated on the imaging server.

4. The method of claim 3 further comprising:
determining which content is selected by the customer; and
installing the content selected by the customer as customized content onto the fixed image platform.

5. The method of claim 1 wherein
the content includes at least one of music content, video content, training content and game application content.

6. The method of claim 1 wherein
the installing includes installing general content and customized content, the general content being installed to a group of fixed image platforms and the customized content being installed onto a particular fixed image platform based upon customer selections.

7. An apparatus for offering and refreshing content on fixed image platforms comprising:
means for storing a fixed image on an imaging server;
means for storing content in an imaging server, the content being regularly updated;
means for merging the fixed image and at least some of the content to provide a merged fixed image; and
means for installing the merged fixed image onto a fixed image platform.

8. The apparatus of claim 7 further comprising:
means for enabling a customer to select content to be installed on the fixed image platform.

9. The apparatus of claim 7 further comprising:
means for presenting a list of content available for install, the list of content available being updated when the content is updated on the imaging server.

10. The apparatus of claim 9 further comprising:
means for determining which content is selected by the customer; and
means for installing the content selected by the customer as customized content onto the fixed image platform.

11. The apparatus of claim 7 wherein
the content includes at least one of music content, video content, training content and game application content.

12. The apparatus of claim 7 wherein
the installing includes installing general content and customized content, the general content being installed to a group of fixed image platforms and the customized content being installed onto a particular fixed image platform based upon customer selections.

13. A system for offering and refreshing content on fixed image platforms comprising:
an imaging server, the imaging server storing a fixed image, the imaging server storing content, the content being regularly updated;
a merge module, the merge module merging the fixed image and at least some of the content to provide a merged fixed image; and
an install module, the install module installing the merged fixed image onto a fixed image platform.

14. The system of claim 13 further comprising:
an configurator, the configurator enabling a customer to select content to be installed on the fixed image platform.

15. The system of claim 14 wherein:
the configurator presents a list of content available for install, the list of content available being updated when the content is updated on the imaging server.

16. The system of claim 15 wherein:
the configurator determines which content is selected by the customer; and
the install module installs the content selected by the customer as customized content onto the fixed image platform.

17. The system of claim 13 wherein
the content includes at least one of music content, video content, training content and game application content.

18. The system of claim 13 wherein
the install module installs general content and customized content, the general content being installed to a group of fixed image platforms and the customized content being installed onto a particular fixed image platform based upon customer selections.
